(19) United States
(12) Patent Application Publication
(10) Pub. No.: US 2020/0134537 A1
(43) Pub. Date: Apr. 30, 2020

(54) SYSTEM AND METHOD FOR GENERATING EMPLOYMENT CANDIDATES

(71) Applicant: Ascendify Corporation, San Francisco, CA (US)

(72) Inventors: William Alexander Beason, San Francisco, CA (US); Matthew Leonard Hendrickson, San Francisco, CA (US); Jason Earl Ball, Castro Valley, CA (US)

(21) Appl. No.: 16/260,822

(22) Filed: Jan. 29, 2019

Related U.S. Application Data
(60) Provisional application No. 62/752,616, filed on Oct. 30, 2018.

(51) Int. Cl. G06Q 10/06; G06F 16/953; G06F 16/35; G06N 20/00

(52) U.S. Cl. CPC G06Q 10/063112; G06N 20/00; G06F 16/35; G06F 16/953

(57) ABSTRACT

Systems for determining alternative job titles to use when querying online recruiting databases. Multiple computers are operatively interconnected for determining a set of alternative job titles from a set of job parameters, and using the alternative job titles when querying online job and/or candidate posting corpora. A method embodiment commences upon parsing a given job requisition to identify at least one job title string that corresponds to at least one job title. The job title is normalized in accordance with a set of normalization rules to form a normalized job title string. The normalized job title string is then used to access machine learning models, which are in turn used to classify the job title string and to produce alternative titles that correspond to the job title. The alternative titles are used for querying online job posting corpora to retrieve postings that match at least one of the alternative titles.

### CROSS-REFERENCE TO RELATED APPLICATIONS

This Patent Application claims priority to U.S. Provisional Patent Application No. 62/752,616 entitled “SYSTEM AND METHOD FOR GENERATING EMPLOYMENT CANDIDATES” filed on Oct. 30, 2018 and assigned to the assignee hereof. The disclosures of all prior Applications are considered part of and are incorporated by reference in this Patent Application.

### TECHNICAL FIELD

This disclosure relates to online database querying, and more particularly to techniques to generate alternative job titles when querying for employment candidates.

### DESCRIPTION OF THE RELATED TECHNOLOGY

Computers and computerized databases have become ubiquitous in corporate settings. Such computers and computerized databases used for human resource (HR) functions often include querying capabilities that are used to perform various HR functions including employee development, employee retention, and talent acquisition. With respect to this latter function of talent acquisition, computer querying has advanced to the point that it is possible to access employment histories of many millions of people whose records are electronically distributed and/or “posted” over many online corpora (e.g., Monster.com, Dice, LinkedIn, Dribble, etc.). Accordingly, for purposes of talent acquisition, human resources personnel have access to a wealth of employment histories from many millions of online postings and other network-based repositories.

Strictly as one scenario, if an “Architect” job is to be filled, human resources personnel may form a database query that includes a query containing the search term “Architect”. In some instances, the query may include additional search terms to be matched such as “5 years of experience” or “graduate of Georgia Tech.” Such a query may return many hundreds of thousands of hits for “Architects”, which may include a plurality of more-specific job titles such as, for example, “System Architects”, “Software Architects”, “Hardware Architects”, “Spec-Home Architects” and so on. Although the query may be narrowed to only return results where the job title of a potential employment candidate matches the term “System Architects”, narrowing the query to include the term “System Architect” (rather than “Architect”) would have the undesired effect of returning only hits for which the potential candidate described his job as a “System Architect”. This is undesirable in the context of talent acquisition since there may be many “Hardware Architects” that may possess the sought-after qualifications of potential candidate. Further, there may be many “Software Architects” that possess the sought-after qualifications of potential candidate, and therefore narrowing the query to include the search term “Architecture” may result in missing many potential candidates that possess the sought-after qualifications. In this scenario, a human resources person may execute multiple queries over multiple “reasonable titles” to generate more hits from pools of possible qualified candidates. It often happens in this situation that the queries that human resources personnel and/or recruiters form become very long and complex, and in some cases the query itself may be many pages long.

Unfortunately, merely executing multiple queries over multiple “reasonable titles” to generate more hits from pools of possible qualified candidates has the undesired effect of returning only those query hits for which a candidate's self-described title matches one of the “reasonable titles” that are explicitly considered by the human resources personnel. As such, this brute-force and somewhat blind approach may miss the possibly very large pool of qualified candidates who described their title as “Web Application Architect” or “Backend Application Architect”, and so on. This scenario is further complicated by the fact that (1) ‘new’ job titles emerge over time and (2) ‘old’ titles fade into disuse. For example, the title “Secretary” has been mostly superseded by “Administrative Assistant”.

Another complication arises as a result of optical character recognition (OCR) errors associated with Internet job postings. As an illustrative example, the title “Software Testing Architect” may be incorrectly OCR'd as “Software Testing Architect”, which of course would not match a query that includes the search term “Software Testing Architect”. What is needed is an improved system and method to perform queries of various employment histories, online job postings, and other electronic repositories of potential candidates.

### SUMMARY

The systems, methods and devices of this disclosure each have several innovative aspects, no single one of which is solely responsible for the desirable attributes disclosed herein.

The present disclosure describes systems, methods, and computer program products for identifying alternative job titles for use in job site queries in a manner that increases the efficiency with which computer-based and online-based information may be searched. Certain embodiments are directed to technological solutions for training and maintaining machine learning models to automatically generate, process, and identify alternative job titles to reduce search times, power consumption, and processing resources of various computer systems, databases, and online repositories containing employment information of potential job candidates. In some aspects, the disclosed embodiments provide technical solutions that address the technical problems attendant to the inexorable proliferation of job titles in online job site corpora by improving the manner in which computers work together when processing queries over job sites. Strictly as one example, when using the disclosed techniques, only queries that include job titles that are at least known to exist in job corpora are issued. As such, queries that include terms that cannot be matched are not issued, thus saving computing and networking resources that may otherwise be unnecessarily consumed by both the querying computer as well as the responding computer.

Some embodiments disclosed herein use techniques to improve the functioning of multiple systems within the disclosed environments, and some embodiments advance peripheral technical fields as well. As specific examples, use of the disclosed computer equipment, networking equipment, and constituent devices within the shown environments as described herein and as depicted in the figures provide advances in the technical field of big data searching as well as advances in various technical fields related to machine learning.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure. Like reference numbers and designations in the various drawings indicate like elements.

FIG. 1A shows an example environment in which one or more embodiments of the present disclosure may be implemented.

FIG. 1B shows an example web view of a resumé posting, according to an embodiment.

FIG. 2 shows an illustrative flow chart depicting an example operation for forming job site queries, according to some aspects of the present disclosure.

FIG. 3 shows an illustrative flow chart depicting an example operation for training machine learning models that are used to generate alternative job titles when forming job site queries, according to some aspects of the present disclosure.

FIG. 4 shows an example job description classification operation as used in systems for generating alternative job titles when forming job site queries, according to some aspects of the present disclosure.

FIG. 5A shows an illustrative flow chart depicting an example operation for updating machine learning models that are used to generate alternative job titles, according to some aspects of the present disclosure.

FIG. 5B shows an illustrative flow chart depicting an example operation for updating machine learning models with alternative job titles, according to some aspects of the present disclosure.

FIG. 6 shows a block diagram of an example system for machine learning model access as used in systems for identifying alternative job titles for use in job site queries, according to some aspects of the present disclosure.

FIG. 7 shows an illustrative flow chart depicting another example operation for forming Internet job site queries, according to some aspects of the present disclosure.

FIG. 8A and FIG. 8B show block diagrams of example computer system architectures suitable for implementing embodiments of the present disclosure and/or for use in the herein-described environments.

### DETAILED DESCRIPTION

Aspects of the present disclosure address problems that arise from the inexorable proliferation of job titles in online job site corpora. Some embodiments are directed to approaches for training and maintaining machine learning models to automatically handle such proliferation. The accompanying figures and discussions herein present example environments, systems, methods, and computer program products for identifying alternative job titles for use in job site queries.

### Overview

Embodiments disclosed herein may be used to match potentially qualified candidate resumés or profile postings with a set of job parameters. As used herein, job parameters include a job title string (e.g., “Software Engineer”), which is used to match against any job title that appears in a potentially qualified candidate's posting (e.g., a job site posting, a social media site posting, etc.). Before forming a query that specifies job parameters (e.g., including one or more job titles), a periodically-updated database is queried. The database query returns alternative titles that are semantically similar to one or more job title strings associated with the given job parameters. The alternative titles that are present in the database are known to have similar semantics as the semantics of the one or more job title strings associated with the given job parameters. The degree of similarity between the semantics of the alternative titles and the semantics of the one or more job title strings can be quantitatively determined using a machine learning model. In exemplary embodiments, a machine learning model is seeded by training data that is derived from a seeding set of job descriptions. Each job description in the seeding set has at least one associated job title. In some embodiments, multiple parallel corpora are used when seeding the training data. For example, sets of job titles obtained or derived from any source can be used in parallel with a set of job descriptions obtained or derived from any source. In some cases, the aforementioned parallel corpora use similar or identical language when referring to a job title as compared to language used in a job description. For example, the phrase “Administrative Assistant” may be identified as a job title in a first set of data, while the phrase “Administrative Assistant” is identified in a second set of data as a job description.

Once the machine learning model has been initially trained and integrated with a system for querying, then a given job title can be used to retrieve one or more associated job descriptions, and a given job description can be used to retrieve one or more associated job titles. In some embodiments, such a system for querying can be implemented using a database of machine learning models. In some embodiments, the seeding set includes many title-description pairs from many occupations over many industries and/or professions. In some embodiments, the seeding set includes title-description pairs taken from a large set of such pairs such as are found in certain industry- or government-provided sets of standard occupational classifications (e.g., SOC2018).

Given an instance of the database including the aforementioned machine learning models, the title of a title-description pair can be classified into one or more occupations that have the same or similar job descriptions. For example, suppose that a received title-description pair is given as {“Oncologist”, “Provides medical services to cancer patients” }, and further suppose that the database contains a title-description pair comprising {“Pathologist”, “Provides tissue classification services for treatment of cancer patients” }, then it can be inferred that, since the descriptions have similarities, then the two titles can also be deemed as being similar. In some situations, a hierarchical taxonomy can be used when making inferences. For example, if the title “Oncologist” as well as the title “Pathologist” both occur in the same branch of a hierarchical taxonomy, then the likelihood of an inferred similarity between “Oncologist” and “Pathologist” would increase. In some implementations inferences are made based on weights, where the weights correspond to characteristics of known relationships (e.g., a relationship such as belonging to the same hierarchical level in a hierarchical job description taxonomy).

Another example emerges when considering the errors that occur when performing OCR over a resumé. Suppose that a received title-description pair was given as {“Oncologist”, “Provides medical services to cancer patients” }, and another occurrence of a title-description pair includes {“Oncodogist”, “Provides tissue classification services for treatment of cancer patients” }, then it can be inferred that, since the descriptions have similarities, then the two different titles are similar in spite of the misspelling of “Oncologist” as “Oncodogist”. As another example, in the case that the descriptions are identical or substantially identical (e.g., including the same set of Ngrams), then the two titles, though different, can be deemed to be semantically identical.

As can be seen, when searching for candidates that have certain qualifications (e.g., as suggested by the degree of matching their job histories to a set of job parameters), any or all of the semantically equivalent job titles can be used in the searching. To emphasize, suppose a highly-qualified candidate posted his or her resumé at a job site (e.g., monster.com, dice.com, dribble.com, etc.) and that job site performed an OCR of the candidates resumé that resulted in the error “Oncodogist”. In absence of practice of the herein-disclosed techniques, that qualified candidate may never have been considered merely because the misspelled posted job title “Oncodogist” did not match the job specification parameter “Oncologist”.

Additional features disclosed herein include distinguishing positions or jobs that share identical titles but different functions (e.g., “Architect” in structure design vs. “Architect” in software design). Certain ambiguous titles such as “Intern”, or “Associate”, or “Specialist” can be classified into occupations that emerge from comparing the contents of the “Intern's”, or “Associate's”, or “Specialist's” profile posting to known job descriptions. For purposes of quantifying a match, matches against different titles can be weighted differently or weighted identically. For example, “Software Developer” may be weighted identically to “Software Developer II”).

Example embodiments disclosed herein continuously update the learning models, thus the system learns continues to learn as new titles (e.g., Administrative Assistant) for the same occupation (e.g., Secretary) emerge within the corpora of job histories.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

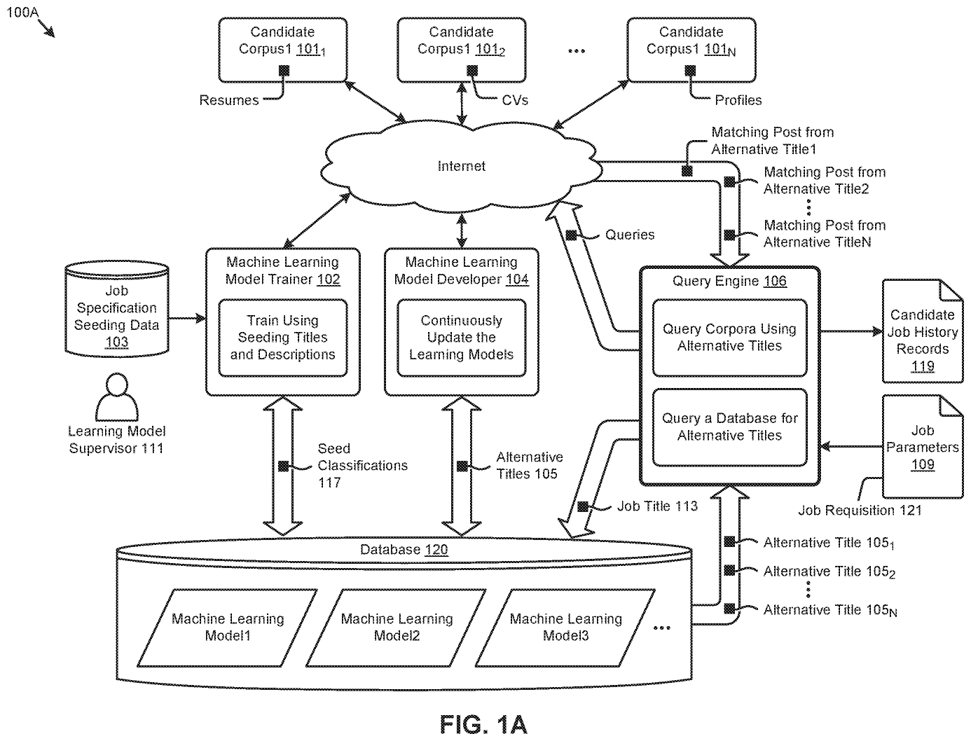

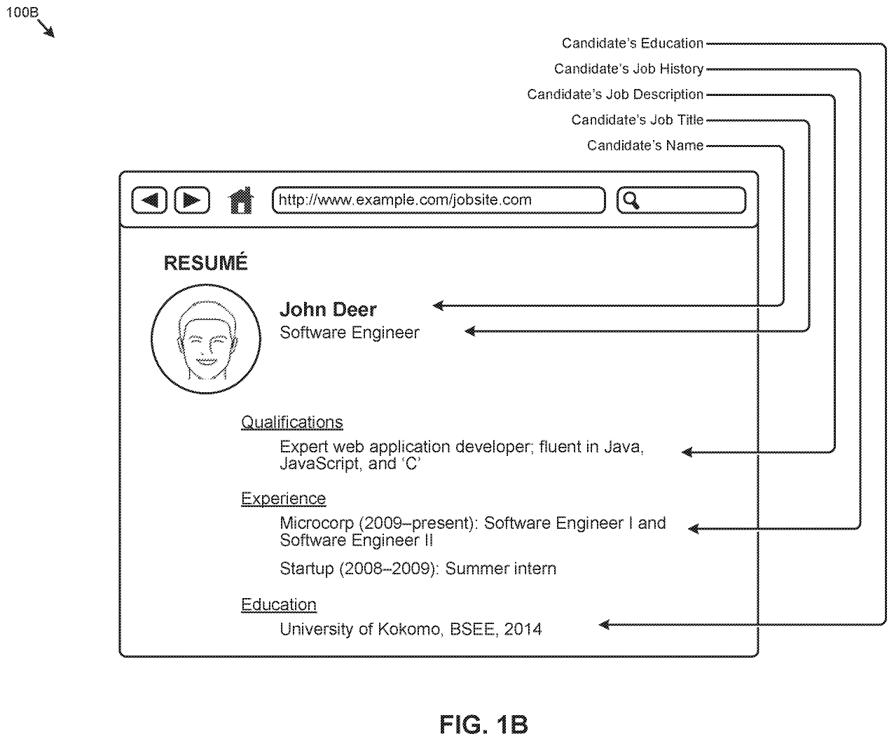

FIG. 1A presents an example environment 100A in which various embodiments of the present disclosure may be implemented. In some aspects, one or more variations of environment 100A or any aspect thereof may be implemented in the context of the architecture and functionality of the embodiments described herein. FIG. 1A is presented for its contribution to addressing problems that arise due to the inexorable proliferation of job titles in online job site corpora. Specifically, FIG. 1A is presented to disclose operations for seeding and maintaining machine learning models. Prior to forming queries to be used in searching online corpora (e.g., job sites, social media sites, etc.), these machine learning models are accessed to retrieve alternative titles that may correspond to a given set of job parameters pertaining to a candidate search.

The embodiment shown in FIG. 1A is merely one example. As shown, the environment 100A includes several Internet sites where job seekers post their resumés and other profiles in the expectation of being considered as a candidate for a job. Many such Internet sites are publicly accessible, and as such any job seeker can post thereto. The posts, in turn, are processed (e.g., checked for relevance and/or against editorial standards) and then stored in one or more data sets such as in an online database and/or in other storage areas that form a corpus of entries (e.g., postings, comments, questions, etc.). The combination of multiple corpora that at least potentially include postings from qualified candidates for a given job are shown as candidate corpus 101₁, candidate corpus 101₂, . . . , and candidate corpus 101_{N}.

A query engine 106 may be configured to consider a set of job parameters 109 and, based on the contents of the job parameters, one or more queries can be generated and submitted to the various online corpora. The data sets of the online corpora are in turn searched, and matching posts are returned. The posts may be in the form of a resumé, or in the form of a curriculum vitae (CV) or in the form of a profile, etc. Regardless of the particular form of the post, the results of the queries are the posts or abstractions of the posts that match a given query.

### Alternative Titles

In at least one embodiment, the query results include at least some matching posts. More specifically, and as shown in FIG. 1A, the results of the queries are the posts or abstractions of the posts that are deemed to match a particular alternative title that was specified in a corresponding query. As heretofore described, there are many reasons why querying over a corpus of online candidate resumé or profile postings using a particular job title may fail to return many qualified candidate's postings. To address this deficiency, queries with compound match criteria and/or multiple queries might be used such that many different alternative titles (e.g., the shown alternative title 105₁, alternative title 105₂, . . . , alternative title 105_{N}) that at least predictably refer to the same occupation can be considered.

Generating different titles that at least predictably refer to the same occupation titles can be facilitated using machine learning operations. The example environment 100A of FIG. 1A uses semi-supervised learning (e.g., supervised learning in combination with unsupervised learning). Specifically, a machine learning model trainer 102 accesses job specification seeding data 103. The job specification seeding data 103 may have been pre-populated with seeding data provided by a learning model supervisor 111. The seeding data includes at least a set of job titles with corresponding one or more descriptions pertaining to the title. For example, the job title “Software Engineer” may have a corresponding description that includes educational and/or other qualifications that pertain to a software engineer. As another example, the job title “Software Engineer” may have a corresponding description that includes an occupational designation such as “technologist” or “knowledge worker”, etc.

The machine learning model trainer 102 includes steps to train machine learning models with seed titles and corresponding seed descriptions. Any number of machine learning models can be stored in a database 120. In some cases, the machine learning models include a machine learning model for each occupational designation. For example, and as shown, the machine learning models can include a machine learning model for each of a provided set of seed classifications 117.

A machine learning model can take the form of an extensible data structure, which extensible data structure can in turn be used to represent sets of words or phrases (e.g., Ngrams) and/or which extensible data structure can be used to represent sets of features (e.g., in feature vectors), etc. Regardless of the specific data structure and/or constitution of a particular machine learning model, the models (e.g., machine learning model1, machine learning model2, machine learning model3, etc.) can be stored in the aforementioned database 120. Database 120 can be accessed using any known technique, either locally or remotely.

The machine learning models, after populated with seed classification, can then be further developed on a continuous, ongoing basis. The example environment 100A of FIG. 1A depicts a machine learning model developer 104 that continuously populates and updates the learning models. One result of such continuous development on an ongoing basis is the learning of new job titles that correspond to a particular occupation. On the basis of the machine learning operations disclosed herein, the machine learning model may be populated with alternative job titles that, at least to a statistically degree of certainty, can be associated with a particular occupation and/or job description.

Having populated the learning models with the learned alternative job titles, the query engine 106 can use a given instance of a job title 113 (e.g., a title as specified in job parameters 109 taken from a job requisition 121) to query the database for job alternative titles. The job alternative titles (e.g., alternative title 105₁, alternative title 105₂, . . . , alternative title 105_{N}) are then used to formulate queries that are performed over the online corpora. The results of the queries to the online corpora include the requested aspects of matching posts. For example, a query of an online corpus may specify that the query results are to include the user ID of a matching post, and/or a query of an online corpus may specify that the query results are to include the post itself, and/or a query of an online corpus may specify that the query results are to include an abstract of the post.

The aforementioned job requisition (e.g., the shown job requisition 121) may be provided in any computer readable form. As used herein, a job requisition is a description of a sought-after candidate (e.g., a human person). The job requisition may be received in the form of an email or other electronic document, and may include text that includes any combination of suggested job titles, and/or suggested or sought-after characteristics of educational background or requirements (e.g., BSEE required, MSEE preferred) and/or suggested or sought-after job experience (e.g., dates of employment by employer, etc.).

Regardless of the specific formulation of the results returned from performance of the online query, the query engine 106 receives sufficient information to access the information of matching postings such that a set of job candidate job history records 119 can be formed. The matching postings may be a social media post, or may be a CV post or a profile post or a resumé post, one example of which resumé posting is shown and described with respect to FIG. 1B.

FIG. 1B shows an example web view of a resumé posting 100B. In some aspects, one or more variations of resumé posting 100B or any aspect thereof may be implemented in the context of the architecture and functionality of the embodiments described herein. The resumé posting 100B or any aspect thereof may be implemented in any environment. This example resumé posting includes a name (e.g., “John Deer”), a job title (e.g., the self-described “Software Engineer”), an indication of role(s) and/or qualification(s), and/or activities undertaken under that title (e.g., the self-described “Expert web application developer”). The resumé posting further includes a job history which, in this example, includes an “Experience” section that provides a breakdown of job history by company, a corresponding time period, and a corresponding title. In this example, the resumé posting also provides the candidates “Education” background. The title in the job description section of the resumé may be used as a key for matching. Alternatively, the title or titles in the job history section may be used as a key for matching.

The foregoing discussions of FIG. 1A and FIG. 1B include concepts pertaining to querying for matches between aspects of a job specification and online postings where alternative titles are used. Such concepts and advantageous applications thereof are disclosed in further detail as follows.

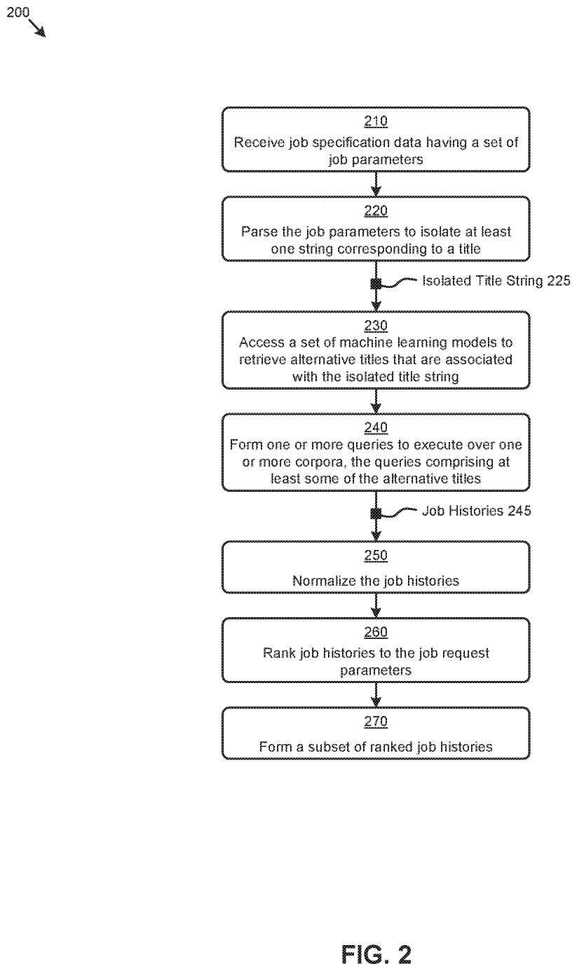

FIG. 2 shows an illustrative flow chart depicting an example operation for forming job site queries. In some aspects, one or more variations of Internet site query operation 200 or any aspect thereof may be implemented in the context of the architecture and functionality of the embodiments described herein. The Internet site query operation 200 or any aspect thereof may be implemented in any environment.

As shown, the operation commences upon receipt of a job specification that includes job parameters (step 210). The parameters may codify candidate search criteria such as a sought-after job title (e.g., “Software Engineer”), any required educational background (e.g., “B.S.E.E.”), and an indication of a number of years of experience (e.g., “at least 5 years”). The job parameters can be parsed to isolate any portions of the job specification that may be used in search criteria (step 220). Any or all of the foregoing candidate search criteria may be parsed from natural language found in a job specification, or any or all of the foregoing candidate search criteria may be delivered as job parameter values corresponding to the job specification.

The result of parsing includes at least one isolated title string 225, which is deemed to be a representative title of a sought-after candidate. Continuing the previous example, a sought-after candidate may correspond to a candidate that now holds or previously held the position or title of “Software Engineer”. However, a qualified sought-after candidate may now hold or have previously held the position or title of “Software Engineer I”, or “Software Engineer II”, or “Sr. Software Engineer”, or “Senior Software Engineer”, etc. To allow for querying for candidates that may hold titles different from the given title (e.g., as in the job parameters), a set of machine learning models are accessed to retrieve alternative titles that are associated with the isolated title string 225.

The isolated title string 225 is received at step 230, which is used as an input to machine learning models that are configured to classify the isolated title string into one or more classifications. The machine learning models that correspond to the classification have one or more associated alternative titles. Some or all of the machine learning models that are configured to classify the isolated title string into one or more classifications can be stored in a database such as database 120 as depicted in the example environment 100A of FIG. 1A. Moreover, such a database is configured to accept an input (e.g., a query) including a job title (e.g., the job title of FIG. 1A) and to return alternative titles (e.g., the alternative titles of FIG. 1A shown as alternative title 105₁, alternative title 105₂, . . . , alternative title 105_{N}). The query language used to access the database 120 can be a known-in-the-art query language such as SQL, or the query used to access the database can be merely a key, such as in the form of a text string or other identifier (e.g., hash value) that corresponds to a job title.

Having retrieved alternative titles that are associated with the isolated title string, step 240 serves to form one or more queries that include at least one of the alternative titles in the query criteria. A query can be submitted to a particular online corpus via any known method, including, but not limited to, via an HTTP “get”, or via an application programming interface (API) call, or via a web service, etc. Performance of the queries (e.g., by computing entities of the particular online corpus) return sufficient information for retrieval of any number of job histories 245 that correspond to the query criteria. Job histories can be received immediately as synchronously-returned query results or can be received at a later time (e.g., as query results from additional processing by the web service or its agents).

Upon receiving the job histories, step 250 serves to normalize the content of the job histories such that job histories received from different corpora can be compared and/or ranked. Normalization subsumes many operations that resolve to data representations that reduce or eliminate insignificant differences. For example, a particular character-level normalization operation converts all text characters to lowercase. Another character-level normalization operation eliminates certain text characters such as apostrophes. Another character-level normalization operation flattens 16-bit Unicode characters into 8-bit ASCII characters. Other normalization techniques can be applied to whole words or phrases. For example, definite and indefinite articles can be eliminated, many different pronouns can be mapped into a pronoun placeholder, and so on.

Other normalization techniques can apply to phrases that are to be considered or dropped based on a likelihood of occurrence of the words in the phrase. Strictly as one example, a Bayesian network may be formed to quantify the likelihood of occurrence of a second word after an occurrence of a first word. Such a Bayesian network can be used to determine if a multi-token phrase is to be considered or not.

Any of the foregoing normalization techniques can be formulated into a set of normalization rules that can be applied to any given data. This includes data as provided in the initial seed title and seed descriptions as well as any data taken from postings. After normalization of the content of the job histories, job histories received from different corpora can be compared and/or ranked.

More specifically, step 260 serves to rank the normalized job histories with respect to a correspondence to the job request parameters. In most cases, some, but not all of the normalized and ranked job histories are to be considered as qualified candidates. Accordingly, step 270 serves to form a subset (e.g., “top 10”) of the normalized and ranked job histories. The subset may then be used to form a report given to HR personnel. The HR personnel may consider some of the “top 10” of the subset of candidates for further action (e.g., for a phone interview, etc.).

Some or all of the steps of FIG. 2 can be performed by one or more components of the system depicted in FIG. 1A. Moreover, some or all of the steps of FIG. 2 can be informed by application of machine learning operations, which operations, either singly or in combination, serve to form and maintain machine learning models. Several of such machine learning operations are disclosed in the following figures.

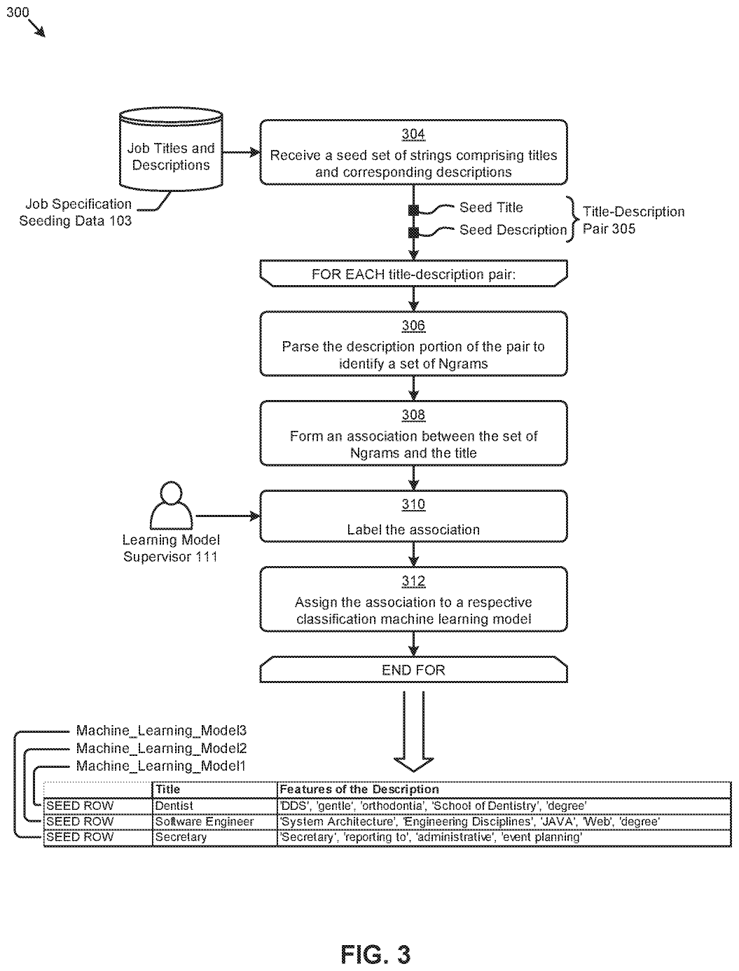

FIG. 3 shows an illustrative flow chart depicting an example operation for training machine learning models that are used to generate alternative job titles when forming job site queries. In some implementations, one or more variations of machine model seeding operation 300 or any aspect thereof may be implemented in the context of the architecture and functionality of the embodiments described herein. The machine model seeding operation 300 or any aspect thereof may be implemented in any environment. In some aspects, machine learning models may have at least one association between a job title or job classification and a job description. The bottom portion of FIG. 3 depicts three machine learning models (i.e., learning model1, learning model2, and learning model 3), each of which include one seed row that informs the association between a seed title (e.g., “Dentist”) and a corresponding seed title description. In this example the description is given as a set of Ngrams (e.g., “‘DDS’, ‘gentle’, ‘orthodontia’, ‘School of Dentistry’, ‘degree’”), however other codifications are possible.

The shown operation commences upon receiving a set of strings that include titles and corresponding descriptions (step 304). The job specification seeding data 103 may include standard occupational classifications (e.g., SOC2018), and/or may include any associations made by a learning model supervisor 111. Although the illustration of FIG. 3 depicts only three machine learning models, certain seed sets may contain many thousands of standard occupational classifications. Accordingly, application of the machine model seeding operation 300 may result in as many thousands of machine learning models.

Once the job specification seeding data has been accessed, then for each title-description pair 305, the description portion of the title-description pair is parsed (at step 306) to identify a set of Ngrams. The Ngrams can include Ngrams with N=1 (single words or tokens) and/or the Ngrams can include Ngrams with the number N being any integer value. In some cases, Ngrams are formed from text items that distinguish between words (e.g., whitespace or punctuation) and/or in some cases Ngrams are formed of intra-word characteristics such as syllables (e.g., based on emphasis or phonemes) or word stems (e.g., based on verb tense).

The Ngrams can be stored as a set of Ngrams, or as an ordered list of Ngrams, or in any extensible data structure. In some embodiments, Ngrams for the stored description are stored in a “hashset” so as to accommodate high performance access to the Ngrams. In some embodiments, the hashset data structure is accessed by built-in methods, some of which offer high performance determination as to the presence or absence of a particular Ngram.

In step 308, an association between the title and description is formed. The association can be an implicit association, such as by storing the title and associated description in the same row of a table, or the association can be explicit such as by using a memory pointer or database key value, or other type of computer identifier. Having established the association, the association itself is labeled with a name (step 310). The labeling can be supervised such as by a learning model supervisor 111, or the labeling can be automatically determined using a representative seed title or version thereof.

Establishing the association and/or naming the association can be performed using any known technique. As examples, the associations as well as the naming can be established through use of a file (e.g., a comma separated file or “.csv”) that establishes an association between a description and an alias by which the description can be accessed. The alias can be numeric identifiers (e.g., “15,1252” or “15,1230”, etc.) or the alias can be a unique string (e.g., “Classification1”, “Classification2”, etc.). Such aliases can be determined and associations made using computer-aided techniques, which computer-aided techniques use heuristics to present options to a learning model supervisor. The learning model supervisor in turn selects from among options to establish an association description and its classification. In certain cases, the act of labeling establishes an association between the title of the title-description pair and the description of the title-description pair.

In the shown examples, the particular labels applied are unique with respect to one another. The determined label is assigned to a corresponding machine learning model (step 312) such that, thereafter, the particular label can be used to refer to its corresponding machine learning model. In this example, the three machine learning models are labeled uniquely as “machine_learning_model1, machine_learning_model2, machine_learning_model3, however they could be labeled using unique titles such as “Dentist”, “Software Engineer”, or “Secretary”, etc. In some cases, use of natural language titles as labels facilitate human comprehension of the classifications. The foregoing steps (i.e., step 306, step 308, step 310, and step 312) are executed for each title-description pair in the shown FOR EACH loop. A large number of title-description pairs would result in a large number of seeded machine learning models.

The seeded machine learning models can be used as predictors or classifiers. Specifically, a subject description can be compared to descriptions in the machine learning models. The comparisons can be quantified. Although none of the comparisons may be an exact match, the quantification of the matches can be ordered such that the highest quantified matches are considered. The classification or label of the highest quantified match predicts the “most likely” title. As such, the learning models can be used as classifiers. More particularly, the Ngrams of the descriptions can be used for comparison to a subject job description. A high correlation between the two informs the classification. As earlier indicated, the classification may result in a job title or an occupation. Groups of learning models can be configured as classifiers to predict a corresponding occupation from a description. Other groups of learning models can be configured to predict a corresponding title from a description. Other groups of learning models can be configured as classifiers to predict a group of alternative titles from a description. Still other groups of learning models can be configured as classifiers to predict a group of alternative titles from a title or occupation.

The choice of which configuration of learning models to use can be based on a then-current purpose. Moreover, in some situations, multiple different classifiers are used to develop a confidence value. Strictly as one example, given a posting, a first set of Ngrams of the posting (e.g., Ngrams from the self-described title in the posting) can be classified into an occupation using a first occupation classifier, while a second set of Ngrams of the posting (e.g., Ngrams from the job history portion of the posting) can be classified into an occupation using a second occupation classifier. Strictly as one example, when the occupations that emerge from two different occupation classifiers are the same occupation, then a high confidence value is assigned as for the occupation classification of that particular posting.

Separate classifiers can be trained using different training sets taken from different portions of seed data. As examples, a first occupation classifier can be trained from the titles given in the seed data, whereas a second occupation classifier can be trained from the job descriptions given in the same seed data. Furthermore, any known-in-the-art classification operations can be used to form classifiers from the seed data. Strictly as one example, a naive Bayes classifier can be used to classify job descriptions to a finite set of occupations.

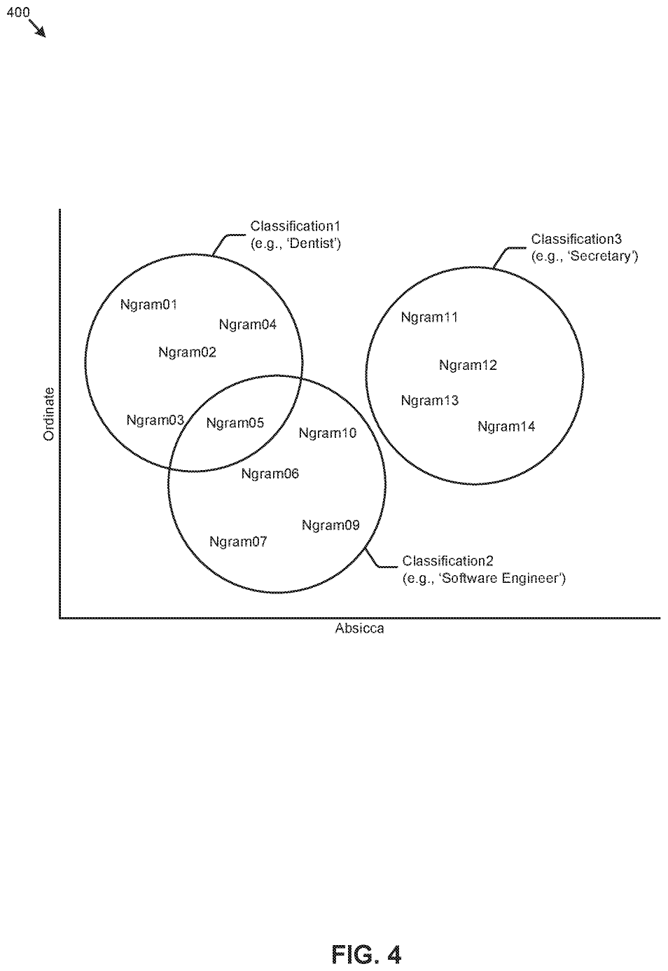

FIG. 4 shows an example job description classification operation 400 as used in systems for generating alternative job titles when forming job site queries. As an option, one or more variations of job description classification operation 400 or any aspect thereof may be implemented in the context of the architecture and functionality of the embodiments described herein. The job description classification operation 400 or any aspect thereof may be implemented in any environment.

FIG. 4 illustrates three classifications shown in two dimensions. Although it is typical that classifications may be composed of many hundreds or thousands or millions of Ngrams or other features, for illustrative purposes, these high-dimensional models are projected onto two dimensions shown as “Abscissa” and “Ordinate”.

As shown, some classifications may have descriptions that are disjoint from one another. This is depicted by the shown “Classification1” and “Classification3”. That is, none of the Ngrams or features of the “Classification1” and “Classification3” intersect. Also shown are classifications that have descriptions that do intersect in whole or in part with one another. This is depicted by the shown “Classification1” and “Classification2”. That is, the Ngram “Ngram05” is common to both “Classification1” and “Classification2”. As such, it is possible that a given subject description may be classified into two or more classifications.

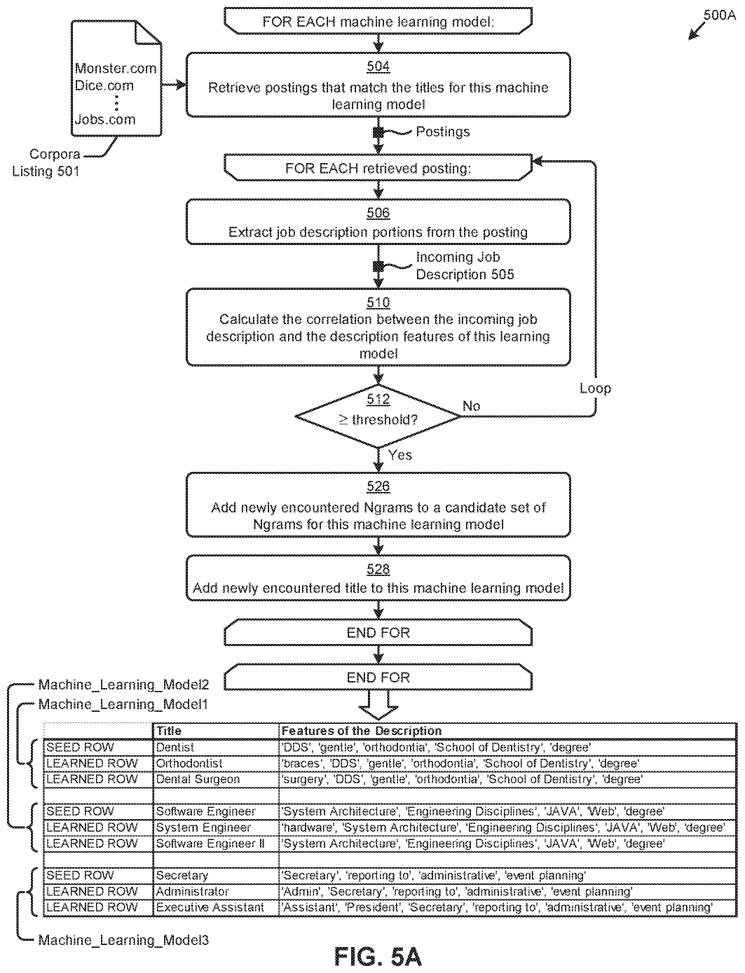

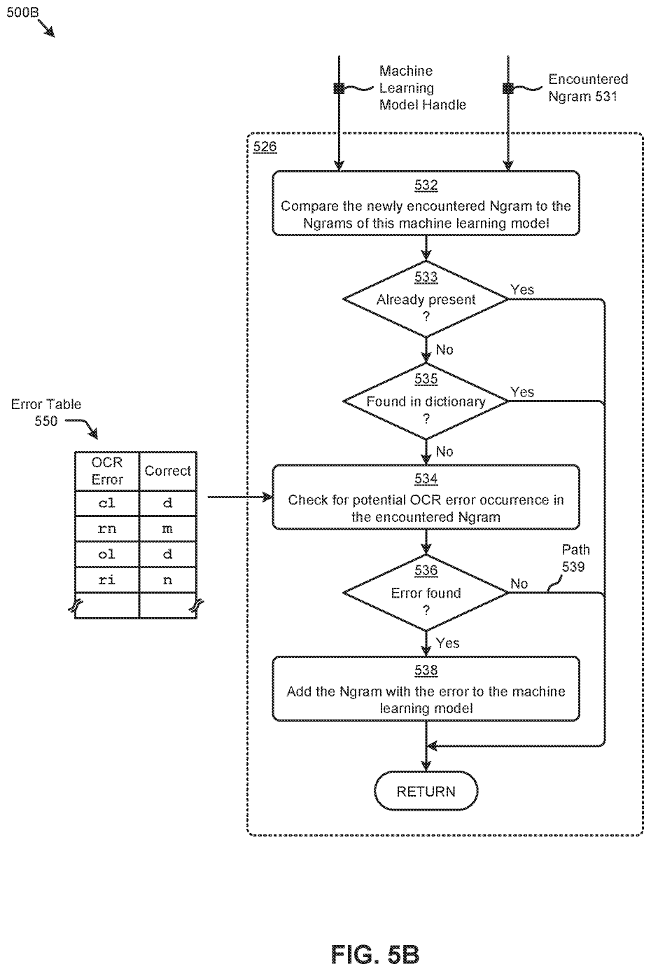

As heretofore described, the seeded classifiers can be used as classifier/predictors, however inasmuch as titles and descriptions change over time, the seeded learning models can be brought to currency by continuously updating the models. Several possible techniques for updating models are given in FIG. 5A and FIG. 5B.

FIG. 5A shows an illustrative flow chart depicting an example operation for updating machine learning models that are used to generate alternative job titles. As an option, one or more variations of machine learning model update operation 500A or any aspect thereof may be implemented in the context of the architecture and functionality of the embodiments described herein. The machine learning model update operation 500A or any aspect thereof may be implemented in any environment.

The example operation of FIG. 5A results in updated learning models. More specifically, the updated learning models include rows in addition to the seed rows. The updates to the machine learning models are shown as “LEARNED ROW”. Each machine learning model (e.g., “machine_learning_model1”, “machine_learning_model2”, “machine_learning_model3”, etc.) of FIG. 5A differs from the respective models of FIG. 3 in that each of the machine learning models of FIG. 5A has such learned rows.

The learned rows are added during the course of performance of step 526 and step 528. More specifically the learned rows result from analysis of postings as retrieved from online job site corpora. The retrieval can be based on sampled postings, or the retrieval can be exhaustive with respect to a time period. For example, a query to an online job site may specify “retrieve all postings that were created or edited on Jan. 31, 2017”.

All learning models can be updated in a loop. As shown, for each machine learning model of the database 120, step 504 serves to query online corpora. Any number of corpora can be given in corpora listing 501, and any number of postings may be returned from the queries of step 504. Having a set of postings that are at least hypothetically related to this learning model, then for each individual ones of such postings, step 506 operates to extract job description portions from the posting. Such extractions result in the shown incoming job descriptions 505.

The operations of step 510 quantifies a correlation (e.g., a quantification of a match, or a quantification of a partial match, or a dot product value, etc.) between the incoming job posting and the description features of this machine learning model. At decision 512, if the quantification of the correlation is below a threshold, then the incoming job description is deemed as not pertaining to this model, and the next posting is considered. Otherwise, if the quantification is equal to or greater than a threshold, then the processing proceeds to the next step. Specifically, at step 526, newly-encountered Ngrams are added to a candidate set of Ngrams. Individual occurrences of Ngrams in this candidate set may, or may not, be added to this learning model. A determination as to whether or not to add a particular Ngram to this model can be made using one or more of a variety of operations (e.g., as described with respect to FIG. 5B).

As is known in the art, the act of updating a machine learning model with newly-encountered Ngrams is a form of unsupervised learning. As such, the determination to add or not to add a newly-encountered Ngram is based on many quantitative measures. Moreover, these quantitative measures may include time-based filtering such that newly-encountered Ngrams are added only after determining their usefulness in improving the accuracy of the machine learning models for classification.

As shown, in the path through step 526 and step 528, newly-encountered titles and/or newly-encountered Ngrams are merely considered to be added to this learning model, but not necessarily added. It is possible and frequent that even when there are newly-encountered Ngrams, no newly-encountered Ngrams are added to the subject learning model. This is because, very frequently, the Ngrams encountered in postings have spelling errors and/or encoding errors and/or OCR errors. In some cases, adding a misspelled or mis-encoded Ngram serves to improve the accuracy of the classifier. In other cases, adding a misspelled or mis-encoded Ngram decreases the accuracy of the classifier. As such, many operations are applied when deciding to add or not to add an Ngram to a machine learning model. One such operation pertains to identification of OCR errors, which is shown and described as pertains to FIG. 5B.

FIG. 5B shows an illustrative flow chart depicting an example operation for updating machine learning models with alternative job titles. In some aspects, one or more variations of optical character recognition error handling operation 500B or any aspect thereof may be implemented in the context of the architecture and functionality of the embodiments described herein. The optical character recognition error handling operation 500B or any aspect thereof may be implemented in any environment.

FIG. 5B illustrates one aspect pertaining to training and maintaining machine learning models. Specifically, FIG. 5B is presented with respect to addressing the problem of handling spelling and other errors encountered in textual portions of candidate resumé or profile postings.

The example operation commences upon receiving a newly-encountered Ngram 531 when analyzing a posting that pertains to a subject machine learning model. At step 532, the newly encountered Ngram is compared to the Ngrams of the subject machine learning model. If, at decision 533, the Ngram is determined to be already present in the subject machine learning model, then the flow returns without adding the Ngram to the subject model. If the Ngram is not in the subject machine learning model, then the Ngram is checked for the possibility that the Ngram is misspelled (step 535). A dictionary can be consulted. In many cases, the language of the posting is known and an applicable dictionary for the particular language is selected. If the Ngram is not found in the applicable dictionary, then it is processed further to determine if the Ngram is a misspelling due to an OCR error. More specifically, if the Ngram is not in the subject machine learning model, and the Ngram is deemed to be misspelled, or for other reasons not in the dictionary, then the Ngram is checked for the possibility that the Ngram exhibits an occurrence or occurrences of well-known OCR errors or spelling variations (step 534).

In this particular embodiment, an error table 550 implements two columns: one column indicates known, commonly-occurring OCR errors or other misspelling errors. The other column indicates a proposed correction for that particular known and commonly-occurring OCR error. Strictly as one example, it frequently happens—especially with proportionally—spaced fonts—that the characters “ol” (e.g., as in “oncology”) are OCR scanned as the character “d”. If the OCR error is so well known and so common as to be present in the error table 550, then the Ngram with the error can be added to the machine learning model.

As such, at decision 536, if one or more of the well-known errors are determined to be present in the encountered Ngram, then at step 538, the Ngram is added to the machine learning model. Otherwise, path 539 is taken and the Ngram is not added to the machine learning model.

As can be understood from the foregoing, when newly-encountered Ngrams are added into a particular machine learning model, its performance is enhanced. Inasmuch as embodiments disclosed herein continuously make updates to the machine learning models, and inasmuch as the updated machine learning models are applied to new posts, the system recursively learns to be able to classify new titles and new descriptions.

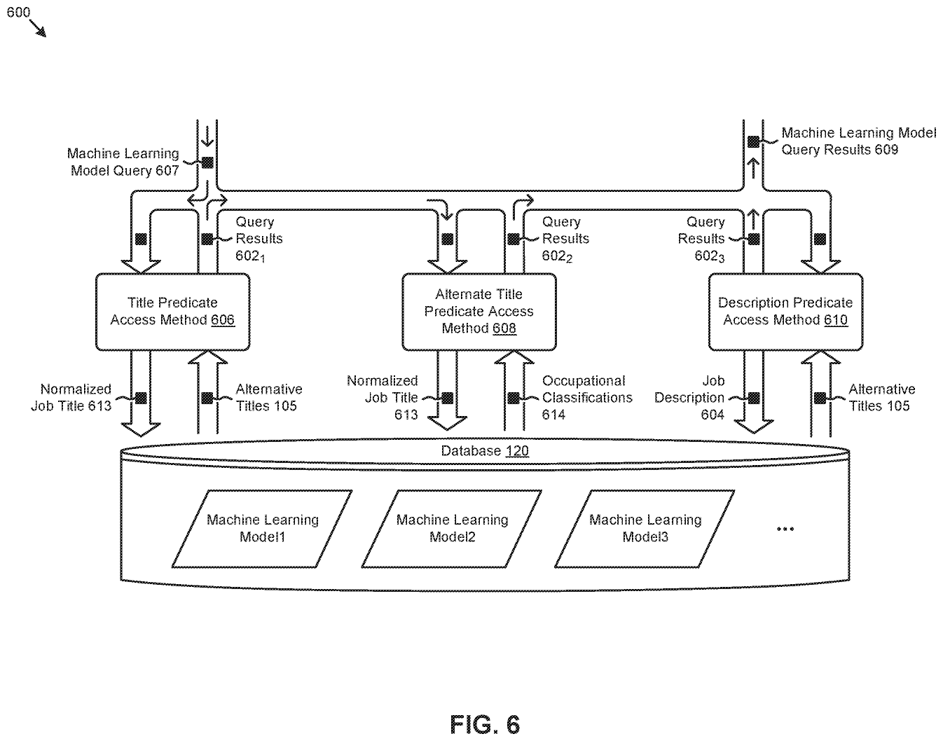

FIG. 6 is a block diagram of a system 600 for machine learning model access as used in systems for identifying alternative job titles for use in job site queries. In some aspects, one or more variations of the system for machine learning model access or any aspect thereof may be implemented in the context of the architecture and functionality of the embodiments described herein. The system for machine learning model access or any aspect thereof may be implemented in any environment.

This example system is presented to illustrate how multiple different types of classifiers can be accessed separately. Specifically, the example system includes a title predicate access method 606 and a description predicate access method 610. The underlying machine learning models are stored in the database 120. These particular machine learning models are purely for illustration. Many embodiments include many hundreds or thousands or more machine learning models in a single system.

The shown system receives a machine learning model query 607 from a caller and processes the query through one or more of the shown access methods. Each individual access method determines its role in providing machine learning model query results 609 and retrieves corresponding results from the database. Each access method is configured to be able to process respective variations of queries so as to return respective variations in query results (e.g., query results 602₁, query results 602₂, query results 602₃, etc.).

In the case that a given machine learning model query 607 specifies a job title (e.g., a normalized job title 613) and that query results are to be in the form of alternative titles, the title predicate access method 606 performs database accesses to retrieve alternative titles 105 from a determined one or more of the machine learning models in the database. In another case, when the machine learning model query 607 specifies a job title (e.g., a normalized job title 613) and that the desired results are to be in the form of an occupational classification, then the shown alternate title predicate access method 608 performs database accesses to retrieve one or more occupational classifications 614 from a determined one or more of the machine learning models in the database. In a third case, when the machine learning model query 607 provides a job description 604 and specifies that the results are to be in the form of an occupational classification, then the shown description predicate access method 610 performs database accesses to retrieve alternative titles 105 from a determined one or more of the machine learning models in the database.

This embodiment supports compound queries to facilitate reduction of network traffic and database query/response “chattiness”. This becomes advantageous in deployment situations where the access methods and the database are located in a geographic and/or network domain different from the geographic/network domain of the caller. In the shown configuration, each access method is configured to process an incoming compound machine learning model query so as to parse out the portion of the query that pertains to the respective access model. As such, the compound query can be sent over the network just one time, even though multiple sub queries may be performed by respective access methods.

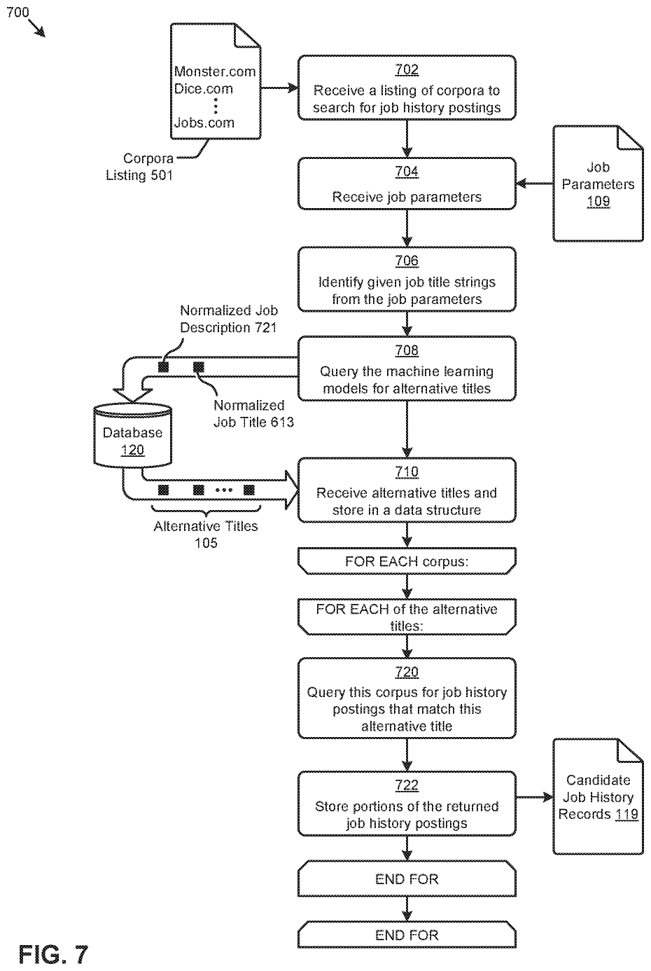

FIG. 7 shows an illustrative flow chart depicting another example operation for forming Internet job site queries. As an option, one or more variations of job history acquisition operation 700 or any aspect thereof may be implemented in the context of the architecture and functionality of the embodiments described herein. The job history acquisition operation 700 or any aspect thereof may be implemented in any environment.

The shown flow serves to process multiple searches over multiple job sites so as to amalgamate relevant portions of many potentially qualified candidates' resumés or profile postings into a set of candidate job history records, which are then considered in subsequent processing.

In many settings, multiple corpora are available to search for potentially qualified candidate resumé or profile postings. A set of available corpora can be maintained in a list (e.g., the shown corpora listing 501). Such a list may include merely a name and/or an Internet address. Also, such a list may be ordered to indicate priorities for carrying out the searches. Step 702 serves to receive the listing of job site corpora to search over to retrieve job history postings. Any number of searches over any number of job sites, and using any number of alternative titles corresponding to a given set of job parameters 109, can be performed. Specifically, and as shown, step 704 and step 706 serves to receive and process job parameters 109 to identify job titles (if any) from the given set of job parameters and to identify a job description from the same given set of job parameters. At step 706, the identified job title or job titles (if any) and the identified job description from the set of job parameters are normalized in accordance with the aforementioned normalization rules.

At step 708, the normalized job title 613 and the normalized job description 721 are formed into one or more machine learning model queries, which are in turn processed through the machine learning models of database 120 to retrieve alternative titles 105. The alternative titles 105 are received at step 710 and stored in a data structure. The alternative titles can now be used to form queries that are performed over the online corpora. Specifically, and as shown at step 720, a query for each individual corpus and for each individual alternative title is submitted. Results of the submitted query are received and all or portions of the query results (e.g., matching job history postings) are stored at step 722 in candidate job history records 119, which are in turn made accessible for further processing.

### System Architecture Overview

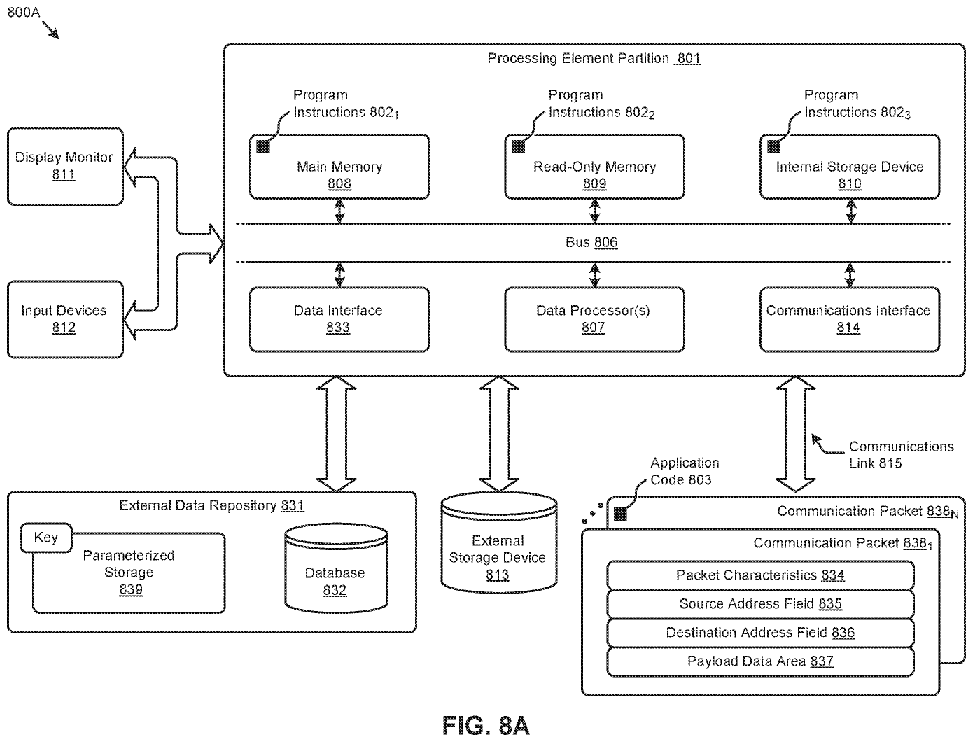

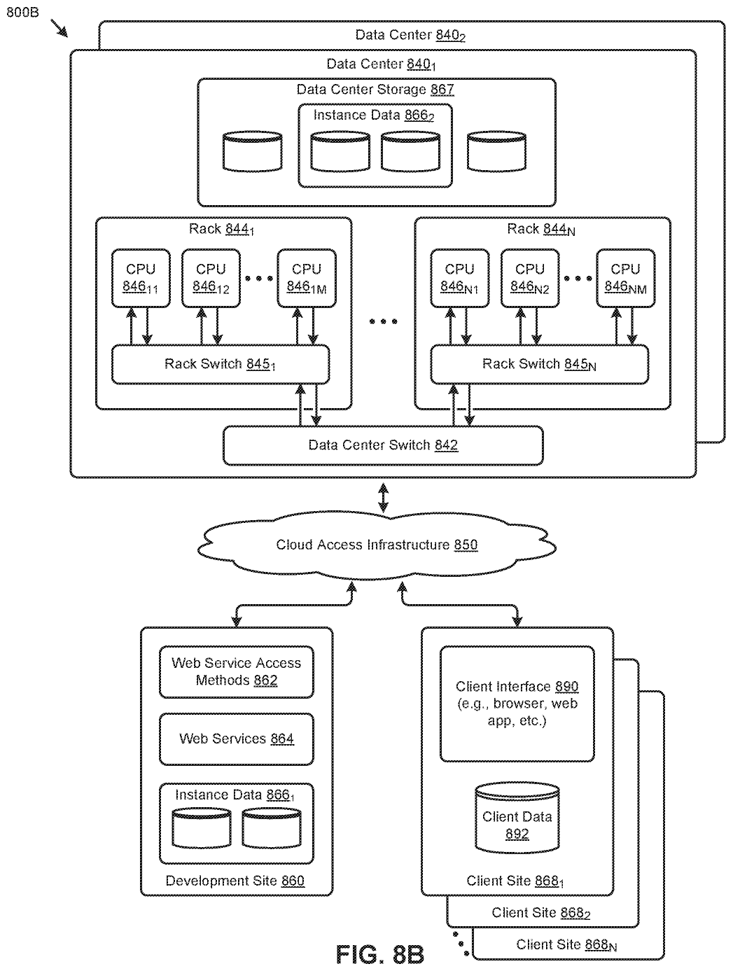

FIG. 8A depicts a block diagram of an instance of a computer system 800A suitable for implementing embodiments of the present disclosure. Computer system 800A includes a bus 806 or other communication mechanism for communicating information. The bus interconnects subsystems and devices such as a CPU, or a multi-core CPU (e.g., data processor 807), a system memory (e.g., main memory 808, or an area of random access memory (RAM)), a non-volatile storage device or non-volatile storage area (e.g., read-only memory or ROM 809), an internal storage device 810 or external storage device 813 (e.g., magnetic or optical), a data interface 833, and a communications interface 814 (e.g., PHY, MAC, Ethernet interface, modem, etc.). The aforementioned components are shown within processing element partition 801, however other partitions are possible. The shown computer system 800A further includes a display monitor 811 (e.g., LCD display, or touchscreen, etc.), various input devices 812 (e.g., keyboard, cursor control), and an external data repository 831. All or portions of computer system 800A can be subsumed into another device such as a smart phone or a pad or tablet.

According to an embodiment of the disclosure, computer system 800A performs specific operations by data processor 807 executing one or more sequences of one or more program code instructions contained in a memory. Such instructions (e.g., program instructions 802₁, program instructions 802₂, program instructions 802₃, etc.) can be contained in or can be read into a storage location or memory from any computer readable/usable medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic and/or can carry out computations and/or processing steps using one or more processes and/or one or more tasks and/or one or more threads or any combination thereof.

According to an embodiment of the disclosure, computer system 800A performs specific networking operations using one or more instances of communications interface 814. Instances of communications interface 814 may include one or more networking ports that are configurable (e.g., pertaining to speed, protocol, physical layer characteristics, media access characteristics, etc.), and any particular instance of communications interface 814 or port thereto can be configured differently from any other particular instance. Portions of a communication protocol can be carried out in whole or in part by any instance of communications interface 814, and data (e.g., packets, data structures, bit fields, etc.) can be positioned in storage locations within communications interface 814, and/or within system memory, and such data can be accessed (e.g., using random access addressing, or using direct memory access (DMA), etc.) by devices such as data processor 807.

Communications link 815 can be configured to transmit (e.g., send, receive, signal, etc.) any types of communications packets (e.g., communications packet 838₁, . . . , communications packet 838_{N}) including any organization of data items. The data items can include a payload data area 837, a destination address field 836 (e.g., a destination IP address), a source address field 835 (e.g., a source IP address), and can include various encodings or formatting of bit fields to populate packet characteristics 834. In some cases, the packet characteristics include a version identifier, a packet or payload length, a traffic class, a flow label, etc. In some cases, payload data area 837 includes a data structure that is encoded and/or formatted to fit into byte or word boundaries of the packet.

In some embodiments, hardwired circuitry may be used in place of, or in combination with, software instructions to implement aspects of the disclosure; thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 807 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge; or any other non-transitory computer readable medium. Such data can be stored, for example, in any form of external data repository 831, which in turn can be formatted into any one or more storage areas, and which can include parameterized storage 839 accessible by a key (e.g., filename, table name, block address, offset address, etc.).

Execution of the sequences of instructions to practice certain embodiments of the disclosure are performed by a single instance of computer system 800A. According to certain embodiments of the disclosure, two or more instances of computer system 800A coupled by a communications link 815 (e.g., LAN, PSTN, or wireless network) may perform the sequence of instructions required to practice embodiments of the disclosure using two or more instances of components of computer system 800A.

Computer system 800A may transmit and receive messages such as data and/or instructions organized into a data structure (e.g., communications packets). The data structure can include program instructions (e.g., application code 803) communicated through communications link 815 and communications interface 814. Received program code may be executed by data processor 807 as it is received and/or stored in the shown storage device, or in or upon any other non-volatile storage for later execution. Computer system 800A may communicate through a data interface 833 to a database 832 in an external data repository 831. Data items in a database can be accessed using a primary key (e.g., a relational database primary key).

Processing element partition 801 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having a plurality of computing elements, any of which computing elements are connected directly or indirectly to a communications link. A first partition can be configured to communicate to a second partition.

A module as used herein can be implemented using any mix of any portions of the system memory and any extent of hardwired circuitry including hardwired circuitry embodied as a data processor 807. Some embodiments include one or more special-purpose hardware components (e.g., power control, logic, sensors, transducers, etc.). A module may include one or more state machines and/or combinational logic used to implement or facilitate the operational and/or performance characteristics pertaining to data access authorization for dynamically generated database structures.

Various implementations of the database 832 include storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of data access authorization for dynamically generated database structures). Such files or records can be brought into and/or stored in volatile or non-volatile memory.

Some embodiments of a module include instructions that are stored in a memory for execution so as to facilitate operational and/or performance characteristics pertaining to identifying alternative job titles for use in job site queries. In some embodiments, a module may include one or more state machines and/or combinational logic used to implement or facilitate the operational and/or performance characteristics pertaining to identifying alternative job titles for use in job site queries.

Various implementations of the data repository include storage media organized to hold a series of records or files such that individual records and/or files are accessed using a name or key (e.g., a primary key or a combination of keys and/or query clauses). Such files and/or records can be organized into one or more data structures (e.g., data structures used to implement or facilitate aspects of identifying alternative job titles for use in job site queries). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to identifying alternative job titles for use in job site queries and/or for improving the way data is manipulated when performing computerized operations pertaining to training and maintaining machine learning models.

FIG. 8B depicts a block diagram of a distributed data processing system 800B that may be included in a system implementing all or portions of systems as disclosed herein. Distributed data processing system 800B can be used to store data, perform computational tasks, and/or transmit data between any computing components that are interfaced with or through the cloud access infrastructure 850. For example, the development site 860 can transmit/receive data to/from a plurality of data centers (e.g., data center 840₁, data center 840₂, etc.). Some of the plurality of data centers may be located geographically close to each other, while others may be located far away from each other.

The components of distributed data processing system 800B can communicate using dedicated optical links and/or other dedicated communication channels, and/or supporting hardware such as modems, bridges, routers, switches, wireless antennas, wireless towers, and/or other hardware components. In some embodiments, the component interconnections of distributed data processing system 800B can include one or more wide area networks (WANs), one or more local area networks (LANs), and/or any combination of the foregoing networks. In certain embodiments, the component interconnections of distributed data processing system 800B can include a private network designed and/or operated for use by a particular enterprise, company, customer, and/or other entity. In other embodiments, a public network may include a portion or all of the component interconnections of distributed data processing system 800B.

In some embodiments, each data center can include multiple racks that each include frames and/or cabinets into which computing devices can be mounted. For example, and as shown, data center 840₁ includes a plurality of racks (e.g., rack 844₁, . . . , rack 844_{N}), each including one or more computing devices. More specifically, rack 844₁ can include a first plurality of CPUs (e.g., CPU 846₁₁, CPU 846₁₂, . . . , CPU 846_{1M}), and rack 844_{N} can include an Nth plurality of CPUs (e.g., CPU 846_{N1}, CPU 846_{N2}, . . . , CPU 846_{NM}). Furthermore, any of the CPUs can include data processors, network attached storage devices, and/or other computer-controlled devices. In some embodiments, at least one of the plurality of CPUs can operate as a master processor, controlling certain aspects of the tasks performed throughout the distributed data processing system 800B. For example, a master processor may control functions that pertain to specialized computing tasks and/or load balancing, data distribution, and/or other processing operations associated with the various tasks performed throughout the distributed data processing system 800B. In some embodiments, one or more of the plurality of CPUs may take on one or more roles, such as a master and/or a slave. In some embodiments, one or more of the plurality of racks can further include data center storage 867 (e.g., one or more locally-attached disks, and/or one or more network attached disks) that can be shared by one or more of the CPUs. The contents of the data center storage can derive from any source.

In some embodiments, the CPUs within a respective rack can be interconnected by a rack switch. For example, the CPUs in rack 844₁ can be interconnected by a rack switch 845₁. As another example, the CPUs in rack 844_{N} can be interconnected by a rack switch 845_{N}. Further, the plurality of racks within data center 840₁ can be interconnected by a data center switch 842. Distributed data processing system 800B can be implemented using other arrangements and/or partitioning of multiple interconnected processors, racks, and/or switches. For example, in some embodiments, the plurality of CPUs can be replaced by a single large-scale multiprocessor.

Also depicted in FIG. 8B are computing sites that are configured to access data centers through cloud access infrastructure 850. The shown development site 860 hosts computer code development activities as well as the shown instance data 866₁ that corresponds to a set of web services 864, which in turn can be accessed any one or more web service access methods 862. The web services 864 can be accessed from client sites through the web service access methods 862 using any sort of client interface 890, such as a browser or web app or device-native application). In some cases, the client interface 890 can access client data 892, which client data can be stored at the client site, and/or in or at any location accessible to the client interface.

In some configurations, there are many hundreds or thousands of client sites (e.g., client site 868₁, client site 868₂, . . . , client site 868_{N}, etc.). The web service access methods include or interface with a plurality of network I/O (input/output or IO) interfaces and/or load balancers and/or other load scalers. Strictly as one example, when one or more of the web access methods determines that the number of client connections exceeds a threshold, then the load scaler may upload (e.g., to a data center) a copy of the web services code together with corresponding web service access methods as well as corresponding web service data. As such, because the data center has a complete copy of all the components needed to implement the web services (e.g., the shown instance data 8662), the data center can handle at least a portion of the load.

The foregoing web services and/or the web service access methods may implement computer hardware and/or computer software that implements capabilities pertaining to machine learning classifiers, and/or that implements capabilities pertaining to natural language processing, as well as other specialized computer processing. In various settings, such specialized computer processing can be used for classification of parameters, parameter values, and/or combinations of parameters and parameter values (e.g., resumé and/or job or occupation parameter classification). Moreover, the web services—whether hosted at the development site or in data centers—can access third party Internet services and/or third party Internet data. Such Internet services and/or Internet data may store historical data. Historical data can include historical touchpoints pertaining to interactions by a real person with an Internet service. Such touchpoints often include computer data (e.g., computer credentials, strings, parameter values, etc.) that characterize various aspects of a real person. The aforementioned Internet data may further include results from one or more parsing engines (e.g., classification engines, natural language processing engines, database engines, etc.) that had been invoked to parse computer data (e.g., string data) that was deemed to be representative of aspects of a real person.

Any one or more of the aforementioned configurations of the distributed data processing system 800B can be used to address performance and/or functional aspects of computing implementations pertaining to identifying alternative job titles for use in job site queries.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A computer-implemented method for determining a set of alternative job titles, the method comprising:
processing a set of job parameters to identify at least one job title string that corresponds to at least one job title;
normalizing the at least one job title string in accordance with a set of normalization rules to form a normalized job title string;
querying a database of machine learning models to retrieve at least one alternative job title based at least in part on the normalized job title string; and
querying at least one online corpus to retrieve at least one entry that matches the at least one alternative job title.

2. The method of claim 1, wherein:
the querying of the database of machine learning models uses a first query language; and
the querying of the at least one online corpus uses a second query language.

3. The method of claim 1, wherein the machine learning models comprise one or more classifiers.

4. The method of claim 3, wherein a first classifier is trained based at least in part on job titles contained in seed data, and wherein a second classifier is trained based at least in part on job descriptions contained in the seed data.

5. The method of claim 1, wherein at least a portion of the set of job parameters is based on a job requisition.

6. The method of claim 1, wherein the at least one alternative job title is generated based on at least a partial match between at least a first portion of the at least one job title string and at least a second portion of a job title stored in a data structure of one or more of the machine learning models.

7. The method of claim 6, wherein the partial match is based at least in part on matching a number of Ngrams.

8. The method of claim 7, wherein at least one of the Ngrams comprises a syllable or a word stem.

9. The method of claim 6, wherein the partial match is based at least in part on a correlation between the first portion of the at least one job title string and a number of features of the database of machine learning models.

10. The method of claim 6, further comprising adding newly-encountered Ngrams to the database of machine learning models.

11. A system for determining a set of alternative job titles, the system comprising:
one or more processors; and
a memory storing instructions that, when executed by the one or more processors, cause the system to:
process a set of job parameters to identify at least one job title string that corresponds to at least one job title;
normalize the at least one job title string in accordance with a set of normalization rules to form a normalized job title string;
query a database of machine learning models to retrieve at least one alternative job title based at least in part on the normalized job title string; and
query at least one online corpus to retrieve at least one entry that matches the at least one alternative job title.

12. The system of claim 11, wherein execution of the instructions further causes the system to:
query the database of machine learning models using a first query language; and
query the at least one online corpus using a second query language.

13. The system of claim 11, wherein the machine learning models comprise one or more classifiers.

14. The system of claim 13, wherein a first classifier is trained based at least in part on job titles contained in seed data, and wherein a second classifier is trained based at least in part on job descriptions contained in the seed data.

15. The system of claim 11, wherein at least a portion of the set of job parameters are derived from a job requisition.

16. The system of claim 11, wherein the at least one alternative job title is generated based on at least a partial match between at least a first portion of the at least one job title string and at least a second portion of a job title stored in a data structure of one or more of the machine learning models.

17. The system of claim 16, wherein the partial match is based at least in part on matching a number of Ngrams.

18. The system of claim 17, wherein at least one of the Ngrams comprises a syllable or a word stem.

19. A non-transitory computer readable medium comprising instructions that, when executed by one or more processors of a device, causes the device to perform operations comprising:
processing a set of job parameters to identify at least one job title string that corresponds to at least one job title;
normalizing the at least one job title string in accordance with a set of normalization rules to form a normalized job title string;
querying a database of machine learning models to retrieve at least one alternative job title based at least in part on the normalized job title string; and
querying at least one online corpus to retrieve at least one entry that matches the least one alternative job title.

20. The non-transitory computer readable medium of claim 19, wherein:
querying the database of machine learning models uses a first query language; and
querying the at least one online corpus uses a second query language.
